(19) United States
(12) Patent Application Publication
(10) Pub. No.: US 2011/0073556 A1
(43) Pub. Date: Mar. 31, 2011

(54) INFANT FORMULA RETORT CONTAINER

(75) Inventors: Sheldon E. Yourist, York, PA (US); Mark O. Borger, York, PA (US)

(73) Assignee: GRAHAM PACKAGING COMPANY, L.P., York, PA (US)

(21) Appl. No.: 12/570,199

(22) Filed: Sep. 30, 2009

(51) Int. Cl. A61J 9/00

(52) U.S. Cl. 215/11.1

(57) ABSTRACT

A retortable container has a body portion that has an angled body portion and a dome-like top portion. The body portion is sized to accommodate being held by an infant or a toddler. The top portion further comprises a finish that is adapted to accommodate a nipple for usage by an infant.

### BACKGROUND OF THE INVENTION

1. Field of the Invention

The present invention is related to the field of containers. In particular the present invention relates to containers adapted to be retortable and filled with infant formula.

2. Description of the Related Technology

Plastic blow-molded containers, particularly those molded of PET, have been utilized in hot-fill applications where the container is filled with a liquid product heated to a temperature in excess of 180° F. (82° C.), capped immediately after filling, and allowed to cool to ambient temperatures. Plastic blow-molded containers have also been utilized in pasteurization and retort processes, where a filled and sealed container is subjected to thermal processing and is then cooled to ambient temperatures.

Pasteurization and retort methods are frequently used for sterilizing solid or semi-solid food products, e.g., pickles and sauerkraut. The products may be packed into the container along with a liquid at a temperature less than 82° C. (180° F.) and then sealed and capped, or the product may be placed in the container that is then filled with liquid, which may have been previously heated, and the entire contents of the sealed and capped container are subsequently heated to a higher temperature. As used herein, “high-temperature” pasteurization and retort are sterilization processes in which the product is exposed to temperatures greater than about 80° C.

Pasteurization and retort differ from hot-fill processing by including heating the filled container to a specified temperature, typically greater than 93° C. (200° F.), until the contents of the filled container reach a specified temperature, for example 80° C. (175° F.), for a predetermined length of time. That is, the external temperature of the hot-filled container may be greater than 93° C. so that the internal temperature of a solid or semi-solid product reaches approximately 80° C. Retort processes may also involve applying overpressure to the container.

Plastic containers have replaced or provided an alternative to glass containers for many applications. However, few food products that must be processed using pasteurization or retort are available in plastic containers. The rigors of such processing present significant challenges for the use of plastic containers, including containers designed for use in hot-fill processing. For example, during a retort process, when a plastic container is subjected to relatively high temperatures and pressures, the plastic container's shape will distort. Upon cooling, the plastic container generally retains this distorted shape or at least fails to return to its pre-retort shape. Accordingly, there remains a need to provide plastic containers that can withstand the rigors of pasteurization and retort processing in order to take advantage of the cost savings that can be realized through manufacture and recycling. The lighter weight of plastic containers as compared to glass can also advantageously reduce shipping costs.

Much like glass containers, the usage of metal containers instead of plastic containers has many disadvantages. Metal containers may be more expensive to produce and the metal containers may ultimately weigh more during shipping. Furthermore, metal containers may dent or be damaged during shipping. Therefore, the usage of plastic in place of metal would also provide a benefit for producers of food products that typically use metal containers.

While using plastic containers is advantageous in the long run. The difficulty in producing such a container that also retains the look and shape of a container that has traditionally held the type of contents to be stored has proven difficult to achieve. Furthermore, with some products such as infant formula, there has not been a plastic container made that is adapted for the retort process so that it may be readily used by an infant or small child. That is to say there are not single serving plastic containers for infant formula that are retortable and ready to be grasped and used by an infant or toddler. Therefore there is a need in the field to produce a container that is sized to be held by an infant or toddler so that they can drink from the container, while also capturing the benefits of being constructed of plastic.

### SUMMARY OF THE INVENTION

An object of the present invention may be a retortable container for infant formula.

Another object of the present invention may be a container adapted to retain a nipple.

Yet another object of the present invention may be a container having a body portion adapted to be retortable.

Still yet another object of the present invention may be a container having a body portion sized to be grasped by an infant.

Yet another object of the present invention may be a container with a plurality of flex panels.

An aspect of the present invention may be a plastic container comprising a top portion, wherein the top portion is dome shaped; a neck portion located below the top portion; a body portion constructed of a plastic material located below the neck; a base portion located below the body portion; and wherein the container is retortable and filled with infant formula.

Another aspect of the present invention may be a plastic container comprising: a top portion, wherein the top portion is dome shaped; a neck portion located below the top portion; a body portion constructed of a plastic material located below the neck portion, wherein the body portion comprises a plurality of flex panels; a base portion located below the body portion; wherein that body portion has a smaller diameter proximate to the neck portion than a diameter taken near the base portion and further wherein the body portion is sized to be grasped by an infant.

Still yet another aspect of the present invention may be a method of hot-filling a container comprising; providing a hot-fill container comprising a top portion having an upper top portion, a first bumper portion located below the upper top portion, and a lower top portion located below the first bumper portion; a body portion located below the lower top portion; and a base portion located below the body portion, wherein the base portion comprises a second bumper portion; gripping the container at the first bumper portion and the second bumper portion; hot-filling the container; and capping the container.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a perspective view of an embodiment of a container constructed in accordance with the present invention.

FIG. 2 is a front view of the container shown in FIG. 1.

FIG. 3 is a side view of the container shown in FIG. 1.

FIG. 4 is a close up view of the flex panel shown in FIG. 1.

FIG. 5 is a cross sectional view of the container shown in FIG. 1 taken along the line A-A.

FIG. 6 is a cross sectional view of the container shown in FIG. 1 taken along the line B-B.

FIG. 7 is a perspective view of another embodiment of a container constructed in accordance with the present invention.

FIG. 8 is a front view of the container shown in FIG. 7.

FIG. 9 is a side view of the container shown in FIG. 7.

FIG. 10 is a close up view of the flex panel shown in FIG. 7.

FIG. 11 is a flow chart of the retort process.

### DETAILED DESCRIPTION OF THE PREFERRED EMBODIMENT(S)

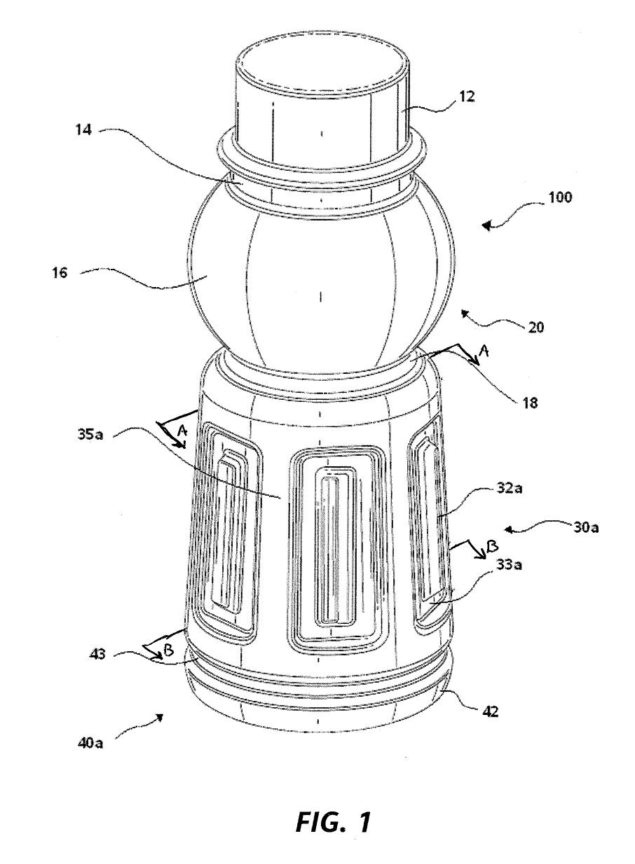

Referring now to the drawings, wherein like reference numerals refer to corresponding structure throughout and referring in particular to FIG. 1, wherein an isometric view of a container 100 is shown that is made in accordance with an embodiment of the present invention.

The container 100 may be a one-piece construction and may be prepared from a monolayer plastic material, such as a polyamide, for example, nylon; a polyolefin such as polyethylene, for example, low density polyethylene (LDPE), high density polyethylene (HDPE), polypropylene, a polyester, for example, polyethylene terephthalate (PET), polyethylene naphtalate (PEN), or others, which may also include additives to vary the physical or chemical properties of the material. For example, some plastic resins may be modified to improve the oxygen permeability. Alternatively, the container may be prepared from a multilayer plastic material. The layers may be any plastic material, including virgin, recycled and reground material. The layers may include plastics or other materials with additives to improve physical properties of the container. In addition to the above-mentioned materials, other materials often used in multilayer plastic containers may be used including, for example, ethylvinyl alcohol (EVOH) and tie layers or binders to hold together materials that are subject to delamination when used in adjacent layers. A coating may be applied over the monolayer or multilayer material to introduce oxygen barrier properties. In an exemplary embodiment, the present container is prepared from PET.

The container 100 is constructed to withstand the rigors of hot-fill processing, a retort process and/or pasteurization. The container 100 may be made by conventional blow molding processes including, for example, extrusion blow molding, stretch blow molding and injection blow molding. These molding processes are discussed briefly below.

In extrusion blow molding, a molten tube of thermoplastic material, or plastic parison, is extruded between a pair of open blow mold halves. The blow mold halves close about the parison and cooperate to provide a cavity into which the parison is blown to form the container 100. As so formed, container 100 may include extra material, or flash, at the region where the molds come together. A moil may be intentionally present above the top portion of the container.

After the mold halves open, the container 100 drops out and is then sent to a trimmer or cutter where any flash of moil attached to the container 100 is removed. The finished container 100 may have a visible ridge (not shown) formed where the two mold halves used to form the container came together. This ridge is often referred to as the parting line.

With stretch blow molding a pre-formed parison, or pre-form, is prepared from a thermoplastic material, typically by an injection molding process. The pre-form typically includes an opened end, which becomes part of the closure of the container 100. The pre-form is positioned between two open blow mold halves. The blow mold halves close about the pre-form and cooperate to provide a cavity into which the pre-form is blown to form the container 100. After molding, the mold halves open to release the container 100

With injection blow molding, a thermoplastic material may be extruded through a rod into an injection mold in order to form a parison. The parison is then positioned between two open blow mold halves. The blow mold halves close about the parison and cooperate to provide a cavity into which the parison may be blown to form the container 100. After molding, the mold halves open to release the container 100.

As discussed above, the plastic blow-molded containers, particularly those molded of PET, may be utilized in hot-fill applications, retort processes and/or pasteurization. Hot-filling involves filling the container 100 with a liquid product heated to a temperature in excess of 180° F. (i.e., 82° C.), capped immediately after filling, and then allowed to cool to ambient temperatures. Pasteurization and retort differ from hot-fill processing by including heating the filled container to a specified temperature, typically greater than 93° C. (200° F.), until the contents of the filled container reach a specified temperature, for example 80° C. (175° F.), for a predetermined length of time. That is, the external temperature of the hot-filled container may be greater than 93° C. so that the internal temperature of a solid or semi-solid product reaches approximately 80° C. Retort processes may also involve applying overpressure to the container

In the construction of containers it is important to keep the container's top load and hot-fill, retort and pasteurization performance characteristics strong. The structural integrity of the container must be maintained after the hot-fill, pasteurization and/or retort process. Furthermore, consideration must be made for preventing bulging of the container 100 that can occur with some containers. When a container 100 is said to be adapted for a hot-fill process, retort process and/or pasteurization process, it is meant that the container 100 is designed and structured so as to withstand the heating and/or over pressuring that are involved in these processes without undergoing significant structural deformation.

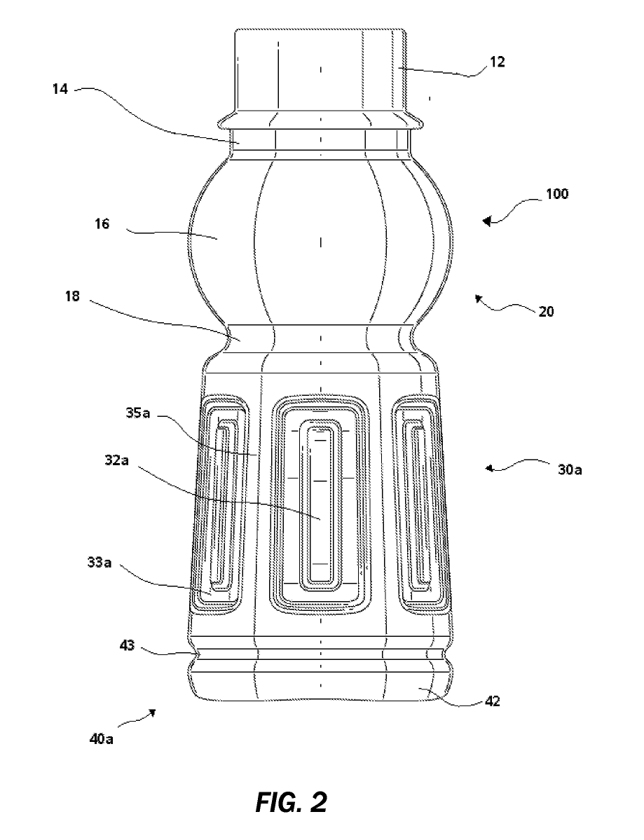

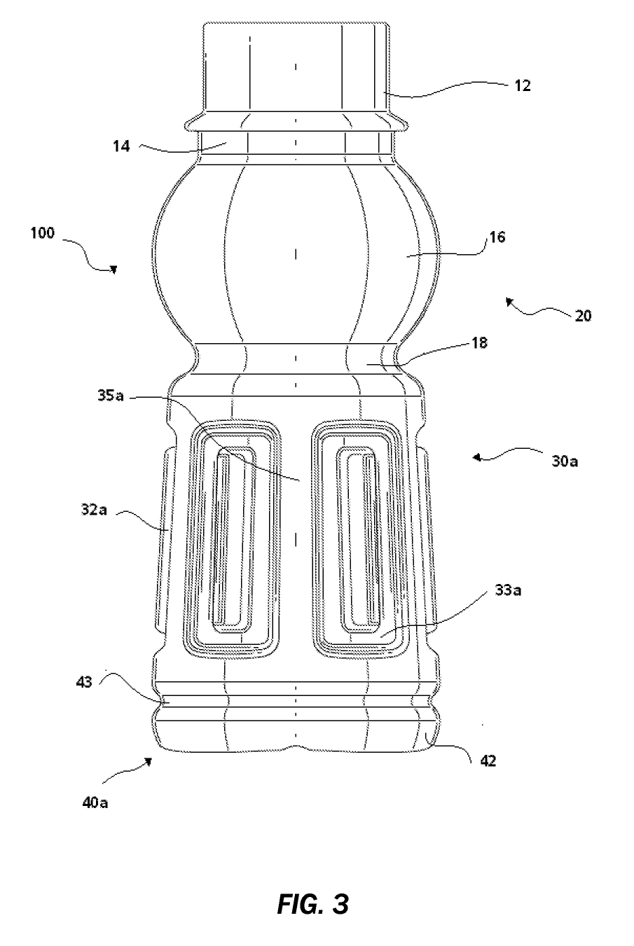

The container 100 shown in FIGS. 1-3 has a finish portion 12 that is located above the top portion 20. The finish portion 12 may be threaded and adapted to retain a nipple for use with an infant. Below the finish portion 12 is the lower flange area 14 that together with the finish portion 12 accommodates the placement of the nipple. The nipple may be placed on the container 100 after removal of a cap that originally sealed the container 100.

The top portion 20 as shown in FIGS. 1-3 is dome shaped and located above the neck 18. By “dome shaped” it is meant that the top portion 20 is generally a partially spherical structure that may also have vertically and/or horizontally sloped surfaces. The top portion 20 has a bumper portion 16 that provides a contact point for the gripping mechanism used on the processing line during the fill process. The bumper portion 16 functions to keep the container 100 straight while on the processing line. It should be understood that while the top portion 20 is shown as dome shaped that other shapes and geometries may be formed so long as there is sufficient structure that may operate as the bumper portion 16.

Located below the neck 18 is the body portion 30a. The body portion 30a shown in FIGS. 1-3 is circular in shape and has a circumference. In the embodiment shown in FIGS. 1-3 the body portion 30a is sloped so that the circumference of the body portion 30a increases as the base portion 40a is approached. The circumference of the body portion 30a is ideally of a size which is graspable by an infant or toddler. The container 100 shown in FIGS. 1-3 is adapted to accommodate 8 oz. of fluid.

The body portion 30a has a flex panel 33a having an island 32a. Located between two flex panels 33a is a column portion 35a. The flex panel 33a may have a trapezoidal shape that has a narrower width towards the portion of the flex panel 33a closest to the neck 18 and a wider shape towards the portion of the container 100 closest to the base portion 40a of the container 100. The flex panels 33a are described in more detail below.

In FIGS. 1-3, the body portion 30a may have six flex panels 33a, as well as islands 32a and column portions 35a. The column portions 35a also provide structure to which a label may be attached. The number of flex panels 33a facilitates the accommodation of container 100 having a circumferential arrangement. The flex panels 33a may also accommodate the vacuum absorption made necessary by the fill process.

The body portion 30a is located above and integrally connected to the base portion 40a via the groove 43. The base portion 40a provides a base bumper portion 42 that provides a contact point for the gripping mechanism used on the processing line during the hot-fill process.

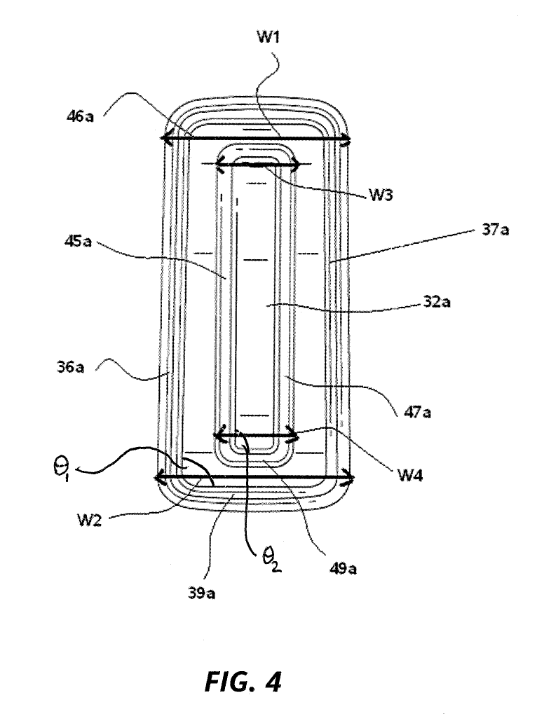

FIG. 4 is a close up view of the flex panel 33a. The flex panel 33a is one of six panels on the container 100 shown in FIGS. 1-3. The flex panel 33a has a first width W1 which is taken from the first side 36a of the flex panel 33a to the second side 37a of the flex panel 33a. The width W1 is taken proximate to the top side 38a of the flex panel 33a. The width W1 is less than the width W2 shown in FIG. 4, which is taken from the first side 36a of the flex panel 33a to the second side 37a of the flex panel 33a. The width W2 is taken proximate to the bottom side 39a of the flex panel 33a. The angle θ₁ formed between the first side 36a of the flex panel 33a and the bottom side 39a of the flex panel 33a is approximately between 89°-85°.

The island 32a is one of six islands on the container 100 shown in FIGS. 1-3. The island 32a has a width W3 which is taken from the first side 45a of the island 32a to the second side 47a of the island 32a. The width W3 is taken proximate to the top side 46a of the island 32a. The width W3 is less than the width W4 shown in FIG. 4, which is taken from the first side 45a of the island 32a to the second side 47a of the island 32a. The width W4 is taken proximate to the bottom side 49a of the island 32a. The angle θ₂ formed between the first side 45a of the island 32a and the bottom side 49a of the island 32a is roughly between 89°-85°. In a preferred embodiment the angle θ₁ is equal to the angle θ₂.

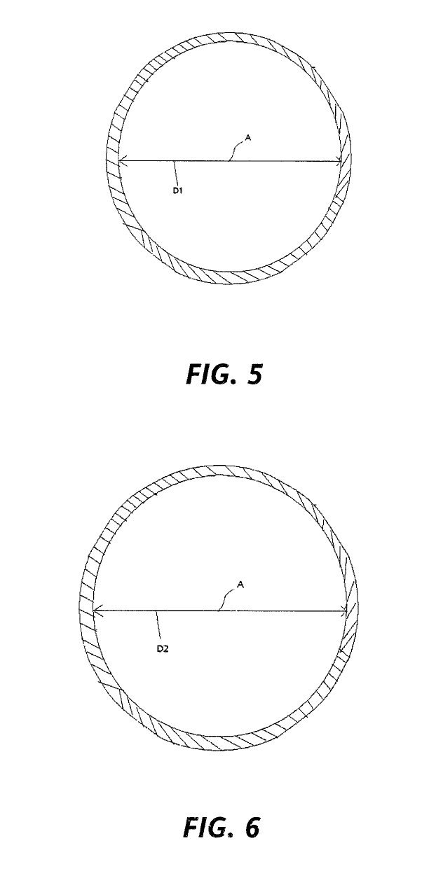

FIG. 5 is a cross sectional view of the container 100 shown in FIG. 1 taken along the line A-A. FIG. 6 is a cross sectional view of the container 100 shown in FIG. 1 taken along the line B-B. The diameter D1 of the container 100 taken along the line A-A is less than the diameter D2 of the container 100 taken along the line B-B.

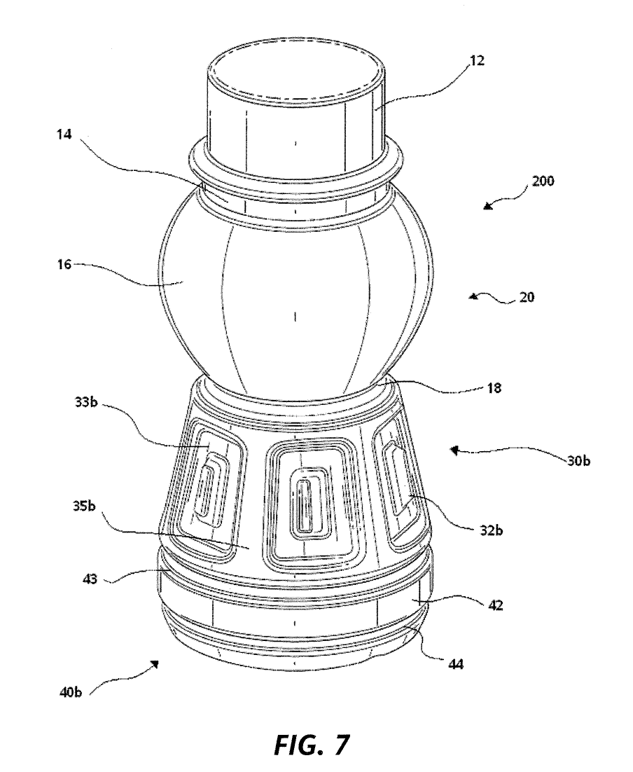

The container 200 shown in FIG. 7 has a neck portion 12 that is located above the top portion 20 that may be threaded so as to accommodate the placement of a nipple. Below the neck portion 12 is the lower flange area 14 that together with the neck portion 12 accommodates the placement of a nipple, much in the same manner as the container 100 shown in FIG. 1. The top portion 20 as shown in FIG. 7 is dome shaped and located above the neck 18. The top portion 20 has a bumper portion 16 that provides a contact point for the gripping mechanism used on the processing line during the fill process. The bumper portion 16 functions to keep the container 200 straight while on the processing line. It should be understood that while the top portion 20 is shown as dome shaped that other shapes and geometries may be formed so long as there is sufficient structure that may operate as the bumper portion 16.

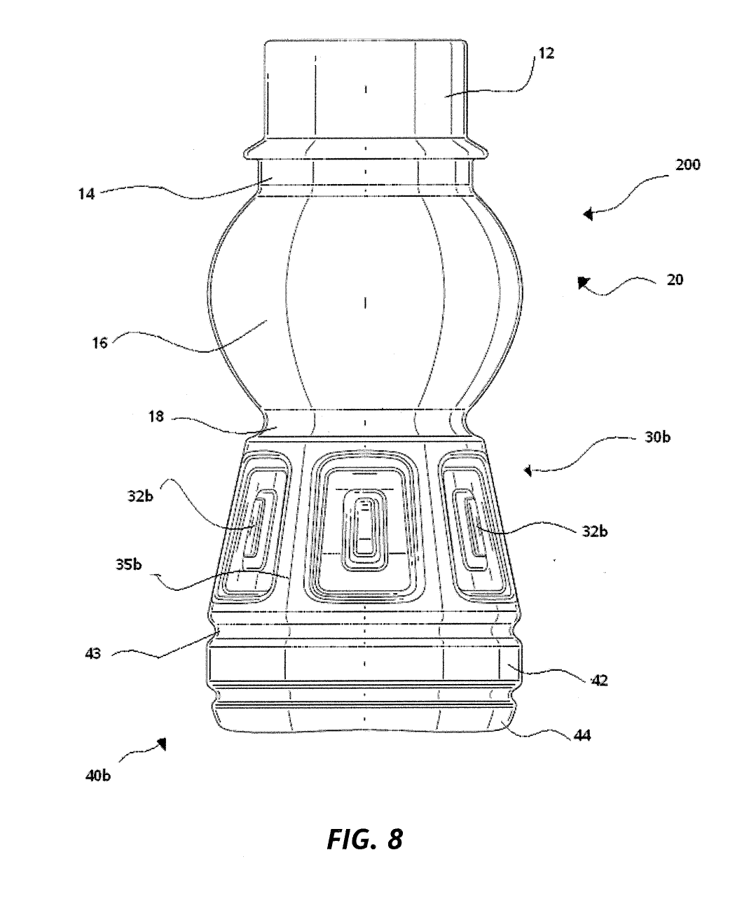

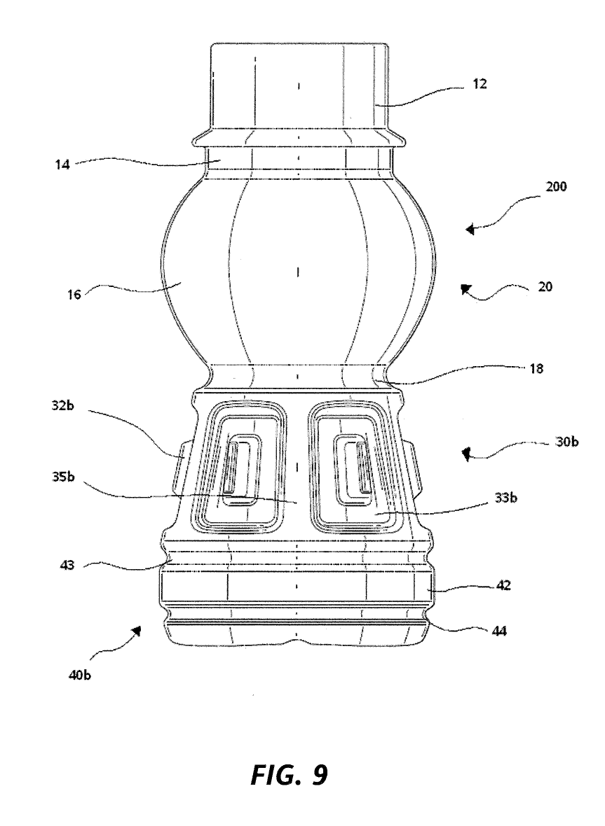

Located below the neck 18 is the body portion 30b. The body portion 30b shown in FIG. 7 is circular in shape and has a circumference. In the embodiment shown in FIG. 7 the body portion 30b is sloped so that the circumference of the body portion 30b increases as the base portion 40 is approached. In contrast to the body portion 30a shown in FIG. 1, the body portion 30b is sloped at an increased angle. The circumference of the body portion 30b is ideally of a size which is graspable by an infant or toddler. The container 200 shown in FIGS. 7-9 is adapted to accommodate 6 oz. of fluid.

The body portion 30b has a flex panel 33b having an island 32b. Located between two flex panels 33b is a column portion 35b. The flex panel 33b may have a trapezoidal shape that has a narrower width towards the portion of the flex panel closest to the neck 18 and a wider shape towards the portion of the container closest to the base portion 40b of the container 200. The flex panels 33b are described in more detail below.

In FIGS. 7-9, the body portion 30b may have six flex panels 33b, as well as islands 32b and column portions 35b. The column portions 35b also provide structure to which the label may be attached. The number of flex panels 33b facilitates the accommodation of container 200 having a circumferential arrangement. The flex panels 33b may also accommodate the vacuum absorption made necessary by the fill process.

The body portion 30b is located above and integrally connected to the base portion 40b via the groove 43. The base portion 40b additionally has another groove 44. The two grooves, 43 and 44, in the base portion 40b provide additional structure for the base portion 40b in order to provide sufficient structure during the hot-fill process, while maintaining the overall aesthetic design. The base portion 40b also provides a base bumper portion 42 that provides a contact point for the gripping mechanism used on the processing line during the hot-fill process.

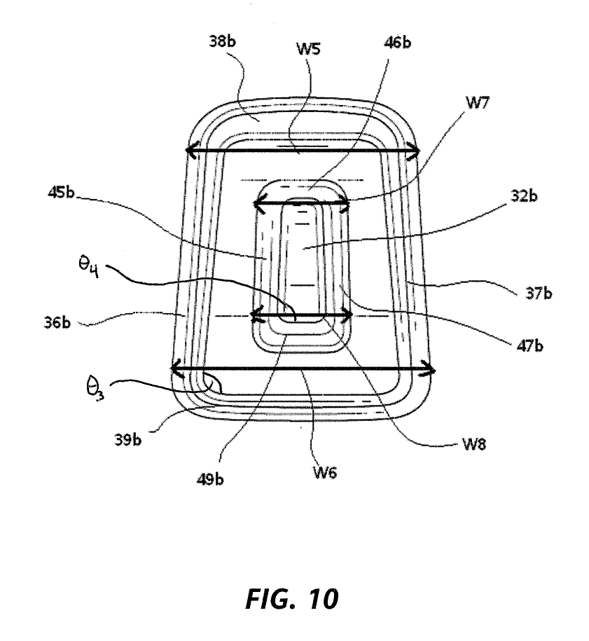

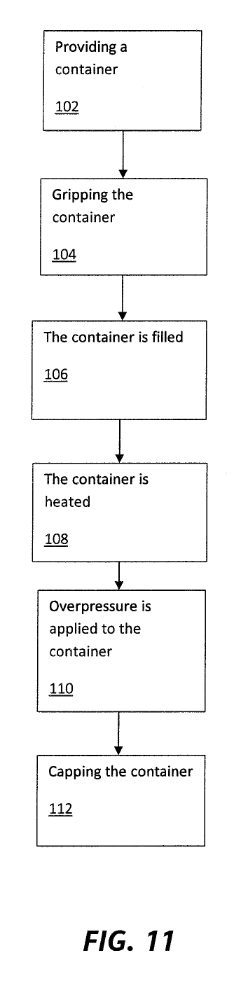

FIG. 10 is a close up view of the flex panel 33b used with the 6 oz. container 200. The flex panel 33b is one of six panels on the container 200 shown in FIGS. 7-9. The flex panel 33b has a first width W5 which is taken from the first side 36b of the flex panel 33b to the second side 37b of the flex panel 33b. The width W5 is taken proximate to the top side 38b of the flex panel 33b. The width W5 is less than the width W6 shown in FIG. 10, which is taken from the first side 36b of the flex panel 33b to the second side 37b of the flex panel 33b. The width W5 is taken proximate to the bottom side 39b of the flex panel 33b. The angle θ₃ formed between the first side 36b of the flex panel 33b and the bottom side 39b of the flex panel 33b is approximately between 89°-65°, and is preferably between 85°-75°.

The island 32b is one of six islands on the container 200 shown in FIG. 10. The island 32b has a width W7 which is taken from the first side 45b of the island 32b to the second side 47b of the island 32b. The width W7 is taken proximate to the top side 46b of the island 32b. The width W7 is less than the width W8 shown in FIG. 10, which is taken from the first side 45b of the island 32b to the second side 47b of the island 32b. The width W8 is taken proximate to the bottom side 49b of the island 32b. The angle θ₄ formed between the first side 45b of the island 32b and the bottom side 49b of the island 32b is roughly between 89°-85°. In a preferred embodiment the angle θ₃ is equal to the angle θ₄.

The containers 100 and 200 utilize the structure to withstand the heating process which may normally distort other containers made from the same material. The flexible panels 33a, 33b and column portions 35a, 35b add to the overall structure and permit it to retain its aesthetic shape during the retort process. The containers 100 and 200 have to go through a process where it is filled with an ambient liquid, gets capped, and is entered into a retort chamber, steamed and pressurized so as the liquid in the container is sterilized until it is safe. The internal liquid temperature can reach up to 255° F. or more. The shape then gets cooled back to room temperature and comes out looking like it did when it went in the retort chamber without distortion.

FIG. 11 is flow chart providing the steps of performing a retort process with the container 100. The same method is applicable to each of the containers disclosed herein. In step 102, the container 10 is provided. In step 104, the container 100 is gripped by the fill machinery, similar to that used in the hot-fill process, which is a process that this container may also undergo. In step 106 the container 100 is filled, which in the present invention is preferably baby formula. In step 108, the container 100 is heated to a specified temperature, typically greater than 93° C. (200° F.), until the contents of the filled container 100 reach a specified temperature, for example 80° C. (175° F.), for a predetermined length of time. That is, the external temperature of the hot-filled container may be greater than 93° C. so that the internal temperature of a solid or semi-solid product reaches approximately 80° C. In step 110, an optional step of applying overpressure to the container 100 is performed. This step is performed sometimes when applying the retort process. In step 110, the container 100 is capped.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A plastic container comprising:
a top portion, wherein the top portion is dome shaped;
a neck portion located below the top portion;
a body portion constructed of a plastic material located below the neck;
a base portion located below the body portion; and
wherein the container is retortable and filled with infant formula.

2. The plastic container of claim 1, further wherein the body portion is sloped and further wherein the body portion is sized to be grasped by an infant.

3. The plastic container of claim 1, wherein the body portion further comprises a plurality of flex panels.

4. The plastic container of claim 3, wherein each of the plurality of flex panels has a first width and a second width, wherein the first width is taken from a first side of the flex panel to a second side of the flex panel proximate to a top side of the flex panel, wherein the second width is taken from a first side of the flex panel to a second side of the flex panel proximate to a bottom side of the flex panel, and further wherein the first width is greater than the second width.

5. The plastic container of claim 4, further comprising an island located within each of the plurality of flex panels, wherein the island comprises a third width and a fourth width, wherein the third width is taken from a first side of the island to a second side of the island proximate to a top side of the island, wherein the fourth width is taken from a first side of the island to a second side of the island proximate to a bottom side of the island, and further wherein the third width is greater than the fourth width.

6. The plastic container of claim 5, wherein a first angle formed between the first side of the flex panel and the bottom side of the flex panel is approximately between 89°-85°.

7. The plastic container of claim 6, wherein a second angle formed between the first side of the island and the bottom side of the island is approximately between 89°-85°.

8. The plastic container of claim 7, wherein the first angle is equal to the second angle.

9. The plastic container of claim 5, wherein a first angle formed between the first side of the flex panel and the bottom side of the flex panel is approximately between 85°-65°.

10. A plastic container comprising:
a top portion, wherein the top portion is dome shaped;
a neck located below the top portion;
a body portion constructed of a plastic material located below the neck, wherein the body portion comprises a plurality of flex panels;
a base portion located below the body portion; and
wherein that body portion has a smaller diameter proximate to the neck than a diameter taken near the base portion and further wherein the body portion is sized to be grasped by an infant.

11. The plastic container of claim 10, wherein each of the plurality flex panels has a first width and a second width, wherein the first width is taken from a first side of the flex panel to a second side of the flex panel proximate to a top side of the flex panel, wherein the second width is taken from a first side of the flex panel to a second side of the flex panel proximate to a bottom side of the flex panel, and further wherein the first width is greater than the second width.

12. The plastic container of claim 11, further comprising an island located within each of the plurality of flex panels, wherein the island comprises a third width and a fourth width, wherein the third width is taken from a first side of the island to a second side of the island proximate to a top side of the island, wherein the fourth width is taken from a first side of the island to a second side of the island proximate to a bottom side of the island, and further wherein the third width is greater than the fourth width.

13. The plastic container of claim 12, wherein a first angle formed between the first side of the flex panel and the bottom side of the flex panel is approximately between 89°-85°.

14. The plastic container of claim 13, wherein a second angle formed between the first side of the island and the bottom side of the island is approximately between 89°-85°.

15. The plastic container of claim 14, wherein the first angle is equal to the second angle.

16. The plastic container of claim 10, wherein a first angle formed between the first side of the flex panel and the bottom side of the flex panel is approximately between 85°-65°.

17. The plastic container of claim 10, wherein the plastic container is retortable.

18. The plastic container of claim 10, wherein the container is filled with infant formula.

19. A plastic container comprising:
a top portion, wherein the top portion is dome shaped;
a neck located below the top portion;
a body portion constructed of a plastic material located below the neck, wherein the body portion further comprises a plurality of flex panels having a plurality of islands located therein;
a base portion located below the body portion; and
wherein the flex panels are trapezoid shaped and further wherein the body portion is sized to be grasped by an infant.

20. The plastic container of claim 19, further wherein each of the plurality flex panels has a first width and a second width, wherein the first width is taken from a first side of the flex panel to a second side of the flex panel proximate to a top side of the flex panel, wherein the second width is taken from a first side of the flex panel to a second side of the flex panel proximate to a bottom side of the flex panel, and further wherein the first width is greater than the second width; wherein each of the islands comprise a third width and a fourth width, wherein the third width is taken from a first side of the island to a second side of the island proximate to a top side of the island, wherein the fourth width is taken from a first side of the island to a second side of the island proximate to a bottom side of the island, and further wherein the third width is greater than the fourth width; and
wherein the container is filled with infant formula.
